(19) United States
(12) Patent Application Publication
(10) Pub. No.: US 2010/0005052 A1
(43) Pub. Date: Jan. 7, 2010

(54) COMPLEMENTING LOCATION AS METADATA

(75) Inventor: Stephane H. Maes, Fremont, CA (US)

Correspondence Address: TOWNSEND AND TOWNSEND AND CREW LLP, TWO EMBARCADERO CENTER, 8TH FLOOR, SAN FRANCISCO, CA, 94111-3834, US

(73) Assignee: Oracle International Corporation, Redwood Shores, CA (US)

(21) Appl. No.: 12/166,541

(22) Filed: Jul. 2, 2008

(51) Int. Cl. G06F 17/30

(52) U.S. Cl. 707/1; 707/100; 707/E17.044; 707/E17.001

(57) ABSTRACT

Embodiments of the invention provide systems and methods for complementing data with spatial data. According to one embodiment, a method of complementing data with spatial data can comprise capturing the data with a device. The spatial data for the device can also be captured. For example, the spatial data can comprise a three coordinate location, a direction in which the device/sensor is oriented, e.g., direction/heading, inclination, etc., when capturing the data, a time at which the data is captured, and/or other information. Capturing the spatial data can comprise determining the spatial data with the device or determining the spatial data with an element of a network communicatively coupled with the device. The spatial data can be associated with the data by assigning the spatial data to metadata of the captured data.

### BACKGROUND OF THE INVENTION

Embodiments of the present invention relate generally to methods and systems for collecting and manipulating media content and more particularly to complementing data with spatial data.

Devices such as digital cameras, digital video cameras, cell phones, smart phones, Personal Digital Assistants (PDAs), portable computers, etc can collect different types of data. For example, a camera or a device equipped with a camera can collect still images and/or video clips. In another example, a device equipped with a microphone can collect audio recordings. A wide variety of other types of data can be collected by devices equipped with various other sensors. The data collected by the device can be transferred from the device to another device in different ways. For example, the data can be transferred to a personal computer or other device during a synchronization operation or other transfer operation via a wired or wireless connection. In another example, the data can be transferred from the device to a personal computer, another device, a server, or other device over a wired or wireless network with which the device is connected. In yet another example, the data can be saved on a machine-readable medium such as a disk or other memory and transferred to another computer or device from the machine-readable medium.

The physical location of a device can be determined in a number of different ways. For example, the location of a mobile device communicating via various wireless technologies can be determined by triangulating the wireless signal between antennas, cell towers, access points, etc. In other cases, technology incorporated on the handset can be used to determine location. For example, many mobile devices now incorporate a Global Positioning System (GPS) receiver that can be used to determine the device's physical location. In other cases, a tracking signal, or data entered by the user may be used to determine the device's location. Furthermore, various standards for determining and utilizing location information for a mobile device have been established. For example, various standard bodies such as 3rd Generation Partnership Project (3GPP), 3rd Generation Partnership Project 2(3GPP2), European Telecommunications Standards Institute (ETSI), Open Mobile Alliance (OMA), International Telecommunications Union (ITU), Parlay, etc. have established technologies for determining location of a device and Application Program Interfaces (APIs) for acquiring and utilizing such information.

However, the data collected by a device and the spatial data for or about that device are not integrated or combined. That is, there are no systems or devices that utilize the available spatial data to complement the data collected by the device to, for example, indicate a location and/or spatial orientation of the device when the data is captured by the device. Furthermore, there are no services available to utilize such combined data. Hence, there is a need for improved methods and systems for collecting and manipulating media content including complementing data with spatial data.

### BRIEF SUMMARY OF THE INVENTION

Embodiments of the invention provide systems and methods for complementing data with spatial data, i.e., location and/or spatial orientation of the device when the data is captured. According to one embodiment, a method of complementing data with spatial data can comprise capturing the data with a device. For example, the data can comprise image data, video data, audio data, and/or any other data collected with one or more sensors of the device. The spatial data for the device can also be captured. For example, the spatial data can comprise a three coordinate location, a direction in which the device/sensor is oriented, e.g., direction/heading, inclination, etc., when capturing the data, a time at which the data is captured, and/or other information. Capturing the spatial data can comprise determining the spatial data with the device or determining the spatial data with an element of a network communicatively coupled with the device. The spatial data can be associated with the data by assigning the spatial data to metadata of the captured data.

A service for accessing the captured data can be provided. In such a case, the captured data and the metadata of the captured data can be provided to the service from the device. Providing the captured data and the associated metadata to the service can comprise providing the captured data and the metadata to the service in real time or non-real time. Providing the service can comprise compiling a collection of captured data. The collection of captured data, i.e., captured data and associated metadata, can comprise captured data from a plurality of devices. In some cases, providing the service can further comprise presenting the collection of data to another device or entity. For example, presenting the collection of captured data can comprise presenting a panoramic or other view constructed from the collection of captured data. In some cases, presenting the collection of captured data can further comprise presenting the spatial data, e.g., three coordinate location from the spatial data and/or the direction from the spatial data. Additionally, presenting the collection of captured data can further comprise manipulating the panoramic view. For example, manipulating the panoramic view can comprise rotating the panoramic view. In another example, manipulating the panoramic view can comprise providing a time evolution view of the panoramic view based on the time at which the data was captured.

According to another embodiment, a system can comprise a communication network, a content service communicatively coupled with the communication network, and a device communicatively coupled with the communication network. The device can be adapted to capture data, capture spatial data related to the device, associate the spatial data with the captured data by assigning the spatial data to metadata of the captured data, and provide the captured data and the metadata of the captured data to the content service via the communication network. In some cases, the device can be adapted to determine the spatial data. Additionally or alternatively, the system can further comprise a location service communicatively coupled with the communication network and the device can be adapted to capture the spatial data by receiving the spatial data from the location service. The spatial data can comprise a three coordinate location, a direction and/or inclination in which the device is oriented when capturing the data, a time at which the data is captured, and/or other information.

The content service can be adapted to compile a collection of captured data. The collection of captured data can comprise data from a plurality of devices. The content service can be further adapted to present the collection of captured data. For example, presenting the collection of captured data can comprise presenting a panoramic or other view constructed from the collection of captured data. In some cases, presenting the collection of captured data to the client can further comprise manipulating the panoramic view, e.g., rotating the panoramic view, providing a time evolution view of the panoramic view based on the time at which the data was captured, etc. Presenting the collection of captured data can further comprise presenting the spatial data, e.g., three coordinate location from the spatial data, the direction from the spatial data, and/or other information.

According to yet another embodiment, a device can comprise a processor and a memory communicatively coupled with and readable by the processor. The memory can have stored therein a series of instructions which, when executed by the processor, cause the device to capture data, capture spatial data related to the device, and associate the spatial data with the captured data by assigning the spatial data to metadata of the captured data. The instructions can further cause the device to determine the spatial data and/or to receive the spatial data. The instructions can further cause the device to provide the captured data and the metadata of the captured data to a content service.

### BRIEF DESCRIPTION OF THE DRAWINGS

FIG. 1 is a block diagram illustrating components of an exemplary operating environment in which various embodiments of the present invention may be implemented.

FIG. 2 is a block diagram illustrating an exemplary computer system in which embodiments of the present invention may be implemented.

FIG. 3 is a block diagram illustrating, at a high-level, functional components of a system for complementing data with spatial data according to one embodiment of the present invention.

FIG. 4 is a flowchart illustrating a process for complementing data with spatial data according to one embodiment of the present invention.

### DETAILED DESCRIPTION OF THE INVENTION

In the following description, for the purposes of explanation, numerous specific details are set forth in order to provide a thorough understanding of various embodiments of the present invention. It will be apparent, however, to one skilled in the art that embodiments of the present invention may be practiced without some of these specific details. In other instances, well-known structures and devices are shown in block diagram form.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “machine-readable medium” includes, but is not limited to portable or fixed storage devices, optical storage devices, wireless channels and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Embodiments of the invention provide systems and methods for utilizing spatial data for or about a device to complement data collected by the device. For example, spatial data for or about the device can be associated with data collected by that device and used to indicate a location, direction of line of sight, inclination, or other location or orientation type information for the device when the data is captured by the device. Stated another way, embodiments of the present invention provide for complementing data with spatial data. According to one embodiment, a method of complementing data with spatial data can comprise capturing the data with a device. For example, the captured data can comprise image data, video data, audio data, and/or other data. The spatial data for the device can also be captured. For example, the spatial data can comprise a three coordinate location, a direction and/or inclination in which the device is oriented when capturing the data, a time at which the data is captured, and/or other information. Capturing the spatial data can comprise determining the spatial data with the device or determining the spatial data with an element of a network communicatively coupled with the device. The spatial data can be associated with the captured data by assigning the spatial data to metadata of the captured data.

According to one embodiment, a service for utilizing such captured data complimented with spatial data can be provided. In such a case, the captured data and the metadata of the captured data can be provided to the service from the device, directly or indirectly, in real time or non-real time. Providing the service can comprise compiling a collection of captured data and associated metadata. The collection of data can comprise captured data and associated metadata from a plurality of devices. In some cases, providing the service can further comprise presenting the collection of captured data, e.g., as a web page viewable through a web browser. For example, presenting the collection of captured data to can comprise presenting a panoramic or other view constructed from the collection of captured data. In some cases, presenting the collection of captured data can further comprise presenting the spatial data associated with the captured data, e.g., the three coordinate location from the spatial data and/or the direction/orientation from the spatial data. Additionally, presenting the collection of captured data can further comprise manipulating the view. For example, manipulating a panoramic view can comprise rotating the panoramic view. In another example, manipulating the view can comprise providing a time evolution view based on the time at which the data was captured. Various additional details of embodiments of the present invention will be described below with reference to the figures.

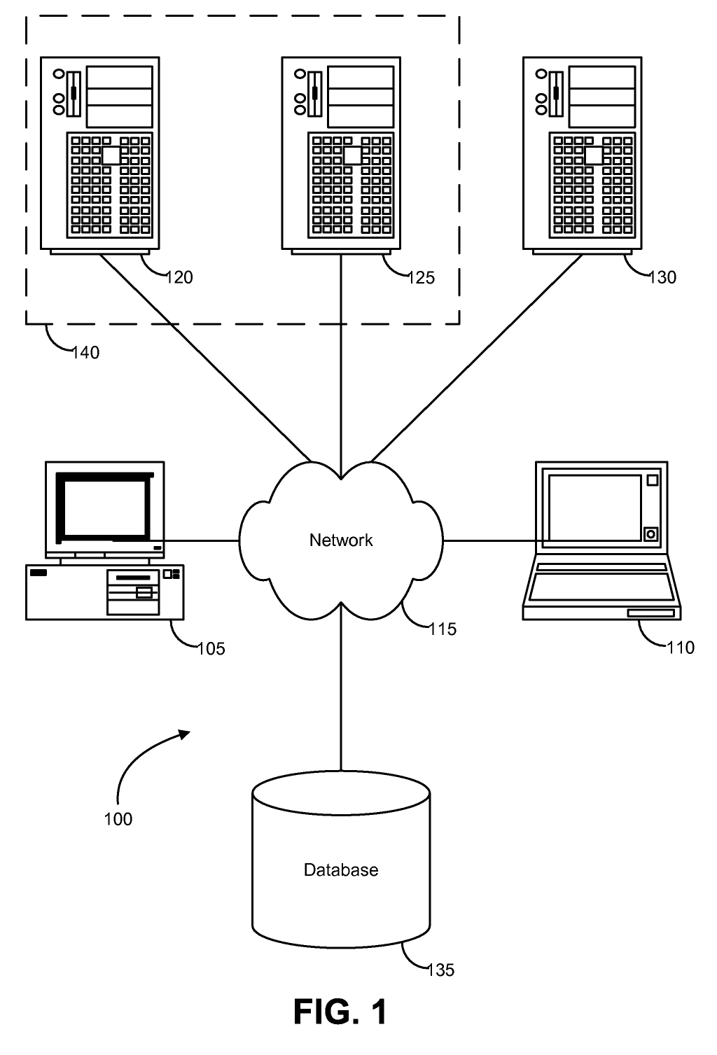

FIG. 1 is a block diagram illustrating components of an exemplary operating environment in which various embodiments of the present invention may be implemented. The system 100 can include one or more user computers 105, 110, which may be used to operate a client, whether a dedicate application, web browser, etc. The user computers 105, 110 can be general purpose personal computers (including, merely by way of example, personal computers and/or laptop computers, Personal Digital Assistants (PDAs), smart phones, set-top boxes, and other computing devices running various versions of Microsoft Corp.'s Windows and/or Apple Corp.'s Macintosh operating systems) and/or workstation computers running any of a variety of commercially-available UNIX or UNIX-like operating systems (including without limitation, the variety of GNU/Linux operating systems). These user computers 105, 110 may also have any of a variety of applications, including one or more development systems, database client and/or server applications, and web browser applications. Alternatively, the user computers 105, 110 may be any other electronic device, such as a thin-client computer, Internet-enabled mobile telephone, and/or personal digital assistant, capable of communicating via a network (e.g. the network 115 described below) and/or displaying and navigating web pages or other types of electronic documents. Although the exemplary system 100 is shown with two user computers, any number of user computers may be supported.

In some embodiments, the system 100 may also include a network 115. The network may can be any type of network familiar to those skilled in the art that can support data communications using any of a variety of commercially-available protocols, including without limitation TCP/IP, SNA, IPX, AppleTalk, and the like. Merely by way of example, the network 115 maybe a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g. a network operating under any of the IEEE 802.11 suite of protocols, the Bluetooth protocol known in the art, and/or any other wireless protocol); and/or any combination of these and/or other networks such as GSM, GPRS, EDGE, UMTS, 3G, 2.5 G, CDMA, CDMA2000, WCDMA, EVDO, HSDPA, femtocells, etc.

The system may also include one or more server computers 120, 125, 130 which can be general purpose computers and/or specialized server computers (including, merely by way of example, PC servers, UNIX servers, mid-range servers, mainframe computers rack-mounted servers, etc.). One or more of the servers (e.g., 130) may be dedicated to running applications, such as a business application, a web server, application server, etc. Such servers may be used to process requests from user computers 105, 110. The applications can also include any number of applications for controlling access to resources of the servers 120, 125, 130.

The web server can be running an operating system including any of those discussed above, as well as any commercially-available server operating systems. The web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers 105, 110. As one example, a server may execute one or more web applications. The web application may be implemented as one or more scripts or programs written in any programming language, such as Java™, C, C# or C++, and/or any scripting language, such as Perl, Python, or TCL, as well as combinations of any programming/scripting languages. The server(s) may also include database servers, including without limitation those commercially available from Oracle®, Microsoft®, Sybase®, IBM® and the like, which can process requests from database clients running on a user computer 105, 110.

In some embodiments, an application server may create web pages dynamically for displaying on an end-user (client) system. The web pages created by the web application server may be forwarded to a user computer 105 via a web server. Similarly, the web server can receive web page requests and/or input data from a user computer and can forward the web page requests and/or input data to an application and/or a database server. Those skilled in the art will recognize that the functions described with respect to various types of servers may be performed by a single server and/or a plurality of specialized servers, depending on implementation-specific needs and parameters.

The system 100 may also include one or more databases 135. The database(s) 135 may reside in a variety of locations. By way of example, a database 135 may reside on a storage medium local to (and/or resident in) one or more of the computers 105, 110, 115, 125, 130. Alternatively, it may be remote from any or all of the computers 105, 110, 115, 125, 130, and/or in communication (e.g., via the network 120) with one or more of these. In a particular set of embodiments, the database 135 may reside in a storage-area network (“SAN”) familiar to those skilled in the art. Similarly, any necessary files for performing the functions attributed to the computers 105, 110, 115, 125, 130 may be stored locally on the respective computer and/or remotely, as appropriate. In one set of embodiments, the database 135 may be a relational database, such as Oracle 10g, that is adapted to store, update, and retrieve data in response to SQL-formatted commands.

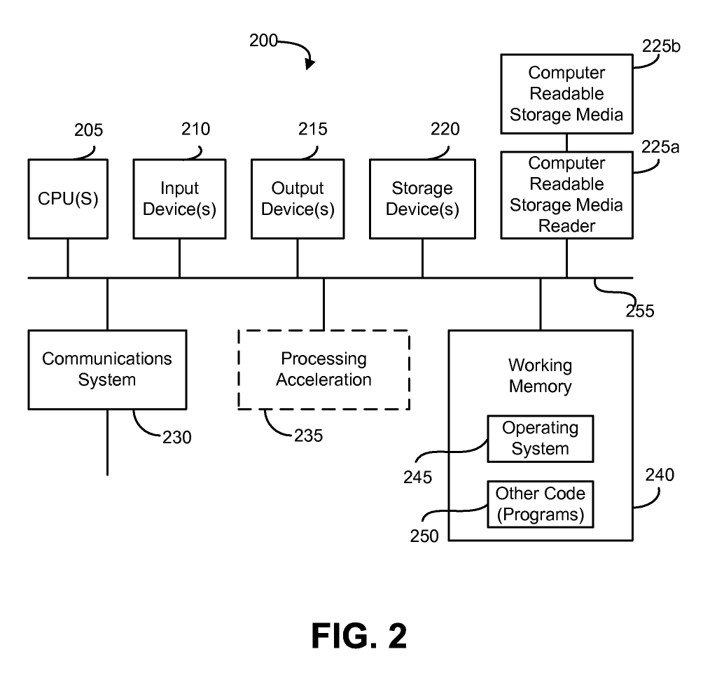

FIG. 2 illustrates an exemplary computer system 200, in which various embodiments of the present invention may be implemented. The system 200 may be used to implement any of the computer systems described above. The computer system 200 is shown comprising hardware elements that may be electrically coupled via a bus 255. The hardware elements may include one or more central processing units (CPUs) 205, one or more input devices 210 (e.g., a mouse, a keyboard, etc.), and one or more output devices 215 (e.g., a display device, a printer, etc.). The computer system 200 may also include one or more storage device 220. By way of example, storage device(s) 220 may be disk drives, optical storage devices, solid-state storage device such as a random access memory (“RAM”) and/or a read-only memory (“ROM”), which can be programmable, flash-updateable and/or the like.

The computer system 200 may additionally include a machine-readable storage media reader 225a, a communications system 230 (e.g., a modem, a network card (wireless or wired), an infra-red communication device, etc.), and working memory 240, which may include RAM and ROM devices as described above. In some embodiments, the computer system 200 may also include a processing acceleration unit 235, which can include a DSP, a special-purpose processor and/or the like.

The machine-readable storage media reader 225a can further be connected to a machine-readable storage medium 225b, together (and, optionally, in combination with storage device(s) 220) comprehensively representing remote, local, fixed, and/or removable storage devices plus storage media for temporarily and/or more permanently containing machine-readable information. The communications system 230 may permit data to be exchanged with the network 220 and/or any other computer described above with respect to the system 200.

The computer system 200 may also comprise software elements, shown as being currently located within a working memory 240, including an operating system 245 and/or other code 250, such as an application program (which may be a client application, web browser, mid-tier application, RDBMS, etc.). It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed. Software of computer system 200 may include code 250 for implementing embodiments of the present invention as described herein.

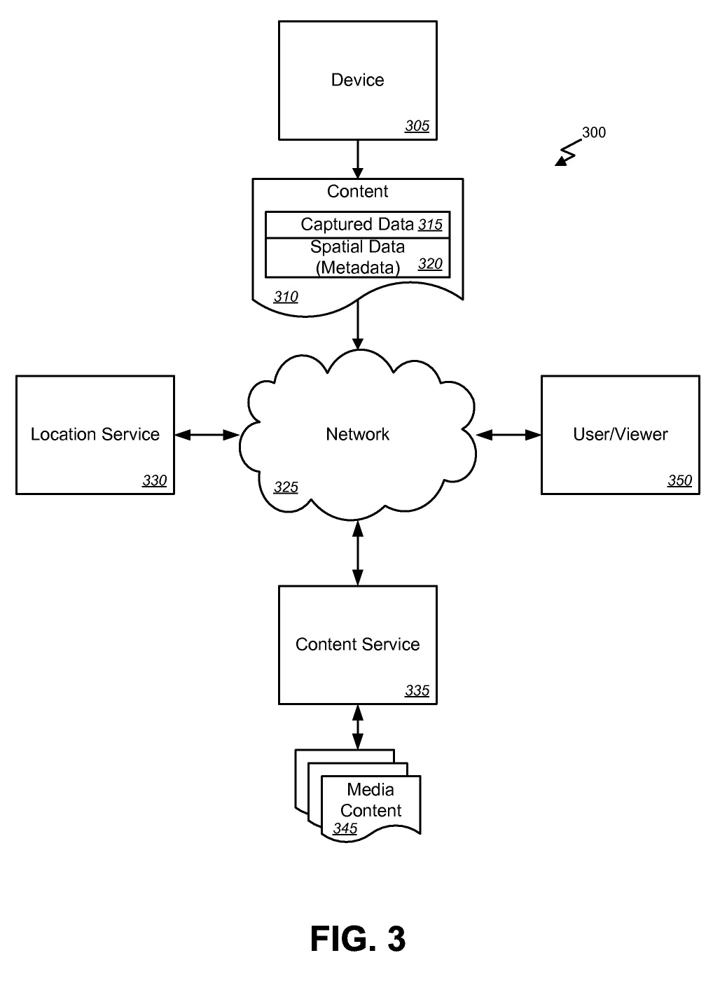

FIG. 3 is a block diagram illustrating, at a high-level, functional components of a system for complementing data with spatial data according to one embodiment of the present invention. As illustrated in this example, the system can include a communication network 325 such as a LAN, WAN, WLAN, Internet, or other network as described above with reference to FIG. 1. It should be understood that the communication network 325 as illustrated here can also represent a combination of multiple networks, e.g., a wireless network such as a cellular network, and/or a wired network such as a LAN, WAN, telephone network, etc., and/or the Internet, and/or other network(s).

The system can also include a device 305. The device 305 can comprise any type of device including but not limited to a digital camera, digital video camera, cell phone, smart phone, Personal Digital Assistant (PDA), computer or any sensor/data collection device. The device 305 can be adapted to capture data. For example, if the device 305 comprises a camera is equipped with a camera, the device can collect data in the form of still images and/or video clips. In another example, if the device 305 equipped with a microphone, the data collected by the device 305 can comprise audio recordings. A wide variety of other types of data can be collected by the device 305 depending upon the sensor(s) that the device 305 may include or comprise.

The device 305 can also be adapted to capture spatial data related to a current location and/or orientation of the device 305, i.e., the physical location, direction of line of sight, inclination, etc., of the device 305 when or while the data is captured. In some cases, the device 305 can be adapted to determine the spatial data. For example, the device 305 can be equipped with a Global Positioning System (GPS) receiver adapted to determine the position of the device in three coordinates, i.e., latitude, longitude, and altitude. In another example, the device 305 can additionally or alternatively include a digital compass and/or inclinometer to determine an orientation of the device 305, i.e., direction of line of sight and/or inclination. In yet another example, the device 305 can additionally or alternatively be adapted to receive the location information from a user of the device 305, e.g., as entered through a user interface in the form of coordinates, an address, or other indication of location.

In some cases, the device 305 can be communicatively coupled with the communication network 325. In such cases, the current location of the device 305 can be determined by other elements of the network 325 and provided to the device 305. For example, the location of the device 305 can be determined by triangulating a wireless signal between antennas, cell towers, access points, etc. Such information can be requested by or provided to the device 305 as known in the art. In some cases, such location information determined by other elements of the network 325 may be combined or supplemented with spatial information determined by the device 305 such as inclination and/or line of sight direction information.

Additionally or alternatively, the system 300 can further comprise a location service 330 communicatively coupled with the communication network 325. In such a case, the current location of the device 305 can be determined by the location service 330 and can provided to the device 305. According to one embodiment, the location service 330 can comprise a service such as described in U.S. patent application Ser. No. 12/014,387 filed Jan. 15, 2008 by Maes and entitled “Using Location as a Presence Attribute” the entire disclosure of which is incorporated by reference for all purposes. In some cases, location information determined by the location service 330 may be combined or supplemented with location information determined by the device 305 such as inclination and/or line of sight direction information.

Regardless of exactly how or where the spatial data is determined, the device 305 can be adapted to associate the spatial data with the captured data. The device 305 can associate the spatial data with the captured data by assigning the spatial data to metadata 320 of or for the captured data 315. The device 305 can then provide content 310 consisting of the captured data 315 and the associated metadata 320, i.e., the captured spatial data, to another element of the system 300 via the communication network 325. For example, the system 300 may include a content service 335 communicatively coupled with the communication network 325. In such a case, the device 305 can provide the content 310 to the content service 335 which can maintain and/or provide access to the content 310 as will be described below. In another example, the device 305 can additionally or alternatively provide the content 310 to a user 350 or other system in a peer-to-peer type exchange. For example, the device 305 can transfer the content 310 to another element of the system such as another device, computer, server, or other element via a wired or wireless synchronization operation. In other cases, the content 305 can be copied or written to a machine-readable medium such as a disc, Compact Disc (CD), Digital Video Disc (DVD), flash or other memory and transferred to another element via the computer readable medium. It should be understood that the device 305 can provide the content 310 directly to the another element, e.g., the content service 335, via the network 325 or indirectly. For example, the device 305 can provide the content 310 to a personal computer (not shown here) via a synchronization or other operation. The personal computer can then in turn provide the content 310 to the content service 335. Furthermore, it should be understood that the device 305 can provide the content 310 to other elements of the system 300 in real time, i.e., as it is being recorded, or non-real time, i.e., at a later time such as via a synchronization operation. Furthermore, it should be understood that the captured data 315 and the metadata 320 can be provided to the service together, e.g., at the same time, along the same path, or as part of the same file such as a content data 310 file as shown here, or separately, i.e., at different times, along different paths, etc. If the metadata 320 is exchanged or provided to the service 335 separate from the captured data 315, it is still possible for the content service 335 to associate the metadata 320 with the captured data 315. For example, the captured data 315 and metadata 320 can cross reference each other or have a URL or other reference that refers to an address from which the addresses of each can be discovered.

Stated another way, the device 305 can comprise a processor and a memory communicatively coupled with and readable by the processor such as described above with reference to FIG. 2. The memory can have stored therein a series of instructions which, when executed by the processor, cause the device 305 to capture data 315, capture spatial data related to a current location of the device 305, and associate the spatial data with the captured data 315 by assigning the spatial data to metadata 320 of or for the captured data 315. The instructions can further cause the device 305 to provide the captured data 315 and the metadata 320 of the captured data to another element of the system 300 such as a content service 335.

The content service 335 can be adapted to compile a collection 345 of media content. It should be understood that while only one device 305 is shown here for clarity, any number of devices may be implemented. Therefore, the collection 345 of media content can comprise content 310, i.e., captured data 315 and associated spatial data as metadata 320, from a plurality of devices. Further, metadata 320 that may be useful for such a service that may be provided include but are not limited to information indicating or describing how the data was collected, the resolution of the data, the type of data captured, the device type, etc. The content service 335 can be further adapted to present the collection 345 of media content to a user 350. For example, the content service 335 can provide access to the collection 345 of media content via a web page viewable through a web browser of the user 350. Presenting the collection 345 of media content to the user 350 can comprise presenting a panoramic or other view constructed from the collection 345 of media content. In some cases, presenting the collection of media content to the user 350 can further comprise manipulating the view, e.g., rotating the panoramic view, providing a time evolution, i.e., time lapse view based on the time at which the data was captured, etc. It should be understood that other presentations for other types of captured data are contemplated and considered to be within the scope of the present invention. Presenting the collection of captured data to the user 350 can further comprise presenting the spatial data, e.g., the three coordinate location of the spatial data, the direction of the spatial data, and/or other spatial information associated with the media content being presented.

For example, the content service 335 can maintain a collection 345 of content related to a particular geographic, historic, and/or other point of interest. In another example, the collection 345 of content may represent views of a house or other real estate. The content service 335 can present views of the location to users/clients via a web page or other interface that may allow the user to manipulate the view and “tour” the location. Additionally or alternatively, the content service can provide details of the location information to the user such as providing the coordinates for the location, an indication of the direction, i.e., heading and/or inclination, of the point of view, the time at which the data was captured, etc.

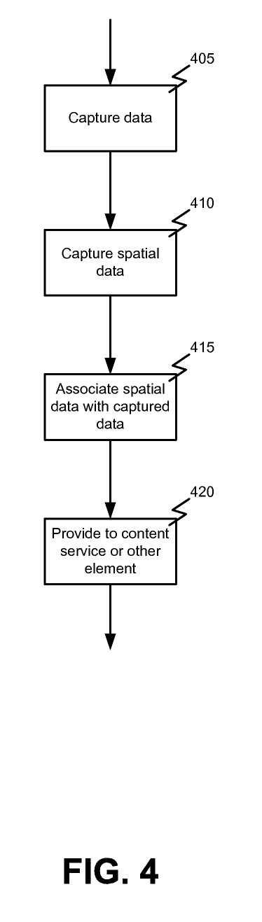

FIG. 4 is a flowchart illustrating a process for complementing data with spatial data according to one embodiment of the present invention. More specifically, this example illustrates a process as may be performed by the device 305 as described above. In this example, the process begins with capturing 405 the data with the device. For example, the data can comprise image data, video data, audio data, and/or other data captured by a sensor of the device. The spatial data for the device can also be captured 410. For example, the spatial data can comprise a three coordinate location, a direction in which the device is oriented when capturing the data, a time at which the data is captured, and/or other information. Capturing 410 the spatial data can comprise determining the spatial data with the device or determining the spatial data with an element of a network communicatively coupled with the device and then provided to the device. In some cases, the spatial data can comprise a combination of information determined by the device and information determined by other elements. The spatial data can be associated 415 with the captured data by assigning the spatial data to metadata of the captured data. The captured data and associated metadata can then be provided 420 to another element of the system such as the content service described above. As noted, the captured data and associated metadata can then be provided directly or indirectly to the other element(s), in real time or non-real time.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A method of complementing data with spatial data, the method comprising:
capturing the data with a device;
capturing the spatial data for the device; and
associating the spatial data with the captured data by assigning the spatial data to metadata of the captured data.

2. The method of claim 1, wherein the captured data comprises image data.

3. The method of claim 1, wherein the captured data comprises video data.

4. The method of claim 1, wherein the captured data comprises audio data.

5. The method of claim 1, wherein capturing the spatial data comprises determining the spatial data with the device.

6. The method of claim 1, wherein capturing the spatial data comprises determining the spatial data with an element of a network communicatively coupled with the device.

7. The method of claim 1, wherein the spatial data comprises a three coordinate location.

8. The method of claim 7, wherein the spatial data further comprises a direction in which the device is oriented when capturing the data.

9. The method of claim 8, further comprising assigning to the metadata of the captured data a time at which the data is captured.

10. The method of claim 8, further comprising assigning to the metadata of the captured data a description of how the data is captured.

11. The method of claim 8, further comprising assigning to the metadata of the captured data a resolution at which the data is captured.

12. The method of claim 8, further comprising assigning to the metadata of the captured data a description of a data type for the captured data.

13. The method of claim 8, further comprising assigning to the metadata of the captured data a description of a device type for the device.

14. The method of claim 9, further comprising:
providing a service for accessing the captured data; and
providing the captured data and the metadata of the captured data to the service from the device.

15. The method of claim 14, wherein providing the captured data and the metadata of the captured data to the service comprises providing the captured data and the metadata of the captured data to the service in real time.

16. The method of claim 14, wherein providing the captured data and the metadata of the captured data to the service comprises providing the captured data and the metadata of the captured data to the service in non-real time.

17. The method of claim 14, wherein providing the captured data and the metadata of the captured data to the service comprises providing the captured data and the metadata of the captured data to the service together.

18. The method of claim 14, wherein providing the captured data and the metadata of the captured data to the service comprises providing the captured data and the metadata of the captured data to the service separately.

19. The method of claim 14, wherein providing the service comprises compiling a collection of captured data.

20. The method of claim 19, wherein the collection of captured data comprises captured data from a plurality of devices.

21. The method of claim 19, wherein providing the service comprises presenting the collection of captured data.

22. The method of claim 21, wherein presenting the collection of captured data comprises presenting a view constructed from the collection of captured data.

23. The method of claim 22, wherein presenting the collection of captured data to the client further comprises manipulating the view.

24. The method of claim 23, wherein presenting the collection of captured data to the client further comprises presenting the three coordinate location of the spatial data.

25. The method of claim 23, wherein presenting the collection of captured data to the client further comprises presenting the direction of the spatial data.

26. The method of claim 23, wherein manipulating the view comprises rotating the view.

27. The method of claim 23, wherein manipulating the view comprises providing a time evolution view based on the time at which the data was captured.

28. The method of claim 1, further comprising providing the captured data and the metadata of the captured data to another device.

29. The method of claim 28, wherein providing the captured data and the metadata of the captured data to another device comprises transferring the captured data and the metadata of the captured data to the other device via a synchronization operation.

30. The method of claim 28, wherein providing the captured data and the metadata of the captured data to another device comprises transferring the captured data and the metadata of the captured data to the other device via a network.

31. The method of claim 28, wherein providing the captured data and the metadata of the captured data to another device comprises transferring the captured data and the metadata of the captured data to the other device via a machine-readable medium.

32. A system comprising:
a communication network;
a content service communicatively coupled with the communication network; and
a device communicatively coupled with the communication network and adapted to capture data, capture spatial data related to the device, associate the spatial data with the captured data by assigning the spatial data to metadata of the captured data, and provide the captured data and the metadata of the captured data to the content service via the communication network.

33. The system of claim 32, wherein the device is adapted to determine the spatial data.

34. The system of claim 32, further comprising a location service communicatively coupled with the communication network and wherein the device is adapted to capture the spatial data by receiving the spatial data from the location service.

35. The system of claim 32, wherein the spatial data comprises a three coordinate location.

36. The system of claim 35, wherein the spatial data further comprises a direction in which the device is oriented when capturing the data.

37. The system of claim 36, wherein the device is further adapted to assign to the metadata of the captured data a time at which the data is captured.

38. The system of claim 37, wherein the content service is adapted to compile a collection of captured data.

39. The system of claim 38, wherein the collection of captured data comprises captured data from a plurality of devices.

40. The system of claim 38, further comprising a client and wherein the content service is further adapted to present the collection of captured data.

41. The system of claim 40, wherein presenting the collection of captured data comprises presenting a view constructed from the collection of captured data.

42. The system of claim 41, wherein presenting the collection of captured data further comprises manipulating the view.

43. The system of claim 42, wherein presenting the collection of captured data further comprises presenting the three coordinate location of the spatial data.

44. The system of claim 42, wherein presenting the collection of captured data further comprises presenting the direction of the spatial data.

45. The system of claim 42, wherein manipulating the view comprises rotating the view.

46. The system of claim 42, wherein manipulating the view comprises providing a time evolution view based on the time at which the data was captured.

47. A device comprising:
a processor; and
a memory communicatively coupled with and readable by the processor, the memory having stored therein a series of instructions which, when executed by the processor, cause the device to capture data, capture spatial data related to the device, and associate the spatial data with the data by assigning the spatial data to metadata of the captured data.

48. The device of claim 47, wherein the instructions further cause the device to determine the spatial data.

49. The device of claim 47, wherein the instructions further cause the device to receive the spatial data.

50. The device of claim 47, wherein the instructions further cause the device to provide the captured data and the metadata of the captured data to a content service.
